(19) United States
(12) Patent Application Publication
(10) Pub. No.: US 2020/0292750 A1
(43) Pub. Date: Sep. 17, 2020

(54) OPTICAL FIBER

(71) Applicant: SUMITOMO ELECTRIC INDUSTRIES, LTD., Osaka (JP)

(72) Inventors: Masato SUZUKI, Osaka (JP); Yuki KAWAGUCHI, Osaka (JP); Hirotaka SAKUMA, Osaka (JP); Yoshiaki TAMURA, Osaka (JP); Takemi HASEGAWA, Osaka (JP)

(73) Assignee: SUMITOMO ELECTRIC INDUSTRIES, LTD., Osaka (JP)

(21) Appl. No.: 16/815,038

(22) Filed: Mar. 11, 2020

(30) Foreign Application Priority Data
Mar. 14, 2019 (JP) 2019-047245

(51) Int. Cl. G02B 6/02

(52) U.S. Cl. CPC G02B 6/02038; G02B 6/02009; G02B 6/02395

(57) ABSTRACT

An optical fiber according to an embodiment has a structure for enabling determination of improvement in transmission loss at a preform stage. The optical fiber includes: a core containing Cl and having an average refractive index lower than a refractive index of pure silica glass; a first cladding containing F; a second cladding; and a resin coating, in which an effective area at a wavelength of 1550 nm is 135 μm² or more and 170 μm² or less, a ratio of the effective area to a cutoff wavelength λ_{C} is 85.0 μm or more, a bending loss of an LP01 mode at a wavelength of 1550 nm and at a bending radius of R15 mm is less than 4.9 dB per 10 turns, and the resin coating includes a primary resin layer having a Young's modulus of 0.3 MPa or less.

### TECHNICAL FIELD

The present disclosure relates to an optical fiber.

This application claims the priority based on Japanese Patent Application No. 2019-047245 filed on Mar. 14, 2019, and incorporates all the contents described in the Japanese application.

### BACKGROUND

Patent Document 1 (Japanese Patent Application Laid-Open No. 2014-238526), Patent Document 2 (Japanese Patent Application Laid-Open No. 2015-166853), and Patent Document 3 (Japanese Patent Application Laid-Open No. 2017-62486) disclose optical fibers having a W-type refractive index profile. The W-type refractive index profile is implemented by a core, a first cladding, and a second cladding constituting a depressed cladding structure. The first cladding has a refractive index lower than in the core, and the second cladding has a refractive index lower than in the core and higher than in the first cladding.

In the manufacture of a preform for obtaining an optical fiber having such a W-type refractive index profile, methods such as a rod-in collapse method, a Vapor phase Axial Deposition (VAD) method, an Outside Vapor Deposition (OVD) method are used to form a glass region to be the second cladding on an outer peripheral surface of the glass region to be the core and the first cladding.

### SUMMARY

An optical fiber according to an embodiment of the present disclosure includes a core, a first cladding, a second cladding, and a resin coating. The core includes at least a region which contains chlorine (Cl) and has an average refractive index lower than a refractive index of pure silica glass. The first cladding is disposed so as to surround the core. The first cladding contains at least fluorine (F), and has a refractive index lower than the average refractive index of the core. The second cladding is disposed so as to surround the first cladding, and has a higher refractive index than in the first cladding. The resin coating is disposed so as to surround the second cladding. In particular, an effective area A_{eff} at a wavelength of 1550 nm is 130 μm² or more and 170 μm² or less. A ratio (A_{eff}/λ_{C}) of the effective area A_{eff} to a cutoff wavelength λ_{C} is 85.0 μm or more. A bending loss of an LP01 mode at a wavelength of 1550 nm and at a bending radius of R15 mm is less than 4.9 dB per 10 turns. The resin coating includes a primary resin layer having at least a Young's modulus of 0.3 MPa or less.

### BRIEF DESCRIPTION OF THE DRAWINGS

FIG. 1 is a diagram illustrating an example of a cross-sectional structure of an optical fiber;

FIG. 2A is a diagram illustrating an example of a refractive index profile of an optical fiber;

FIG. 2B is a diagram illustrating another example of the refractive index profile of the optical fiber;

FIGS. 3A-1 and 3A-2 are tables summarizing specifications of optical fibers according to Samples 1 to 13 of the present embodiment;

FIGS. 3B-1 and 3B-2 are tables summarizing a bending loss of the optical fibers according to Samples 1 to 13 of the present embodiment;

FIGS. 4A-1 and 4A-2 are tables summarizing specifications of optical fibers according to comparative examples 1 to 11;

FIGS. 4B-1 and 4B-2 are tables summarizing a bending loss of the optical fibers according to comparative example 1 to comparative example 11;

FIG. 5 is a graph illustrating a relationship between a transmission loss increase (dB/km) at a wavelength of 1550 nm and A_{eff}/λ_{C} (μm) based on the transmission loss of Sample 1;

FIG. 6 is a graph illustrating a relationship between a transmission loss increase (dB/km) at a wavelength of 1550 nm and ΔD (%) based on the transmission loss of Sample 1;

FIG. 7 is a graph illustrating a relationship between a transmission loss increase (dB/km) at a wavelength of 1550 nm and ΔP (%) based on the transmission loss of Sample 1;

FIG. 8 is a graph illustrating a relationship between the bending loss (dB per 10 turns) and A_{eff}/λ_{C}(μm) of an LP01 mode at a wavelength of 1550 nm where a bending radius R is set to 15 mm;

FIG. 9 is a graph illustrating an equivalent refractive index profile of an optical fiber with a certain radius of bending;

FIG. 10 is a diagram illustrating each of parameters of an optical fiber;

FIG. 11 is a graph illustrating a relationship between R_{C,eff} (R=15 mm, λ=1550 nm) and ΔD (%);

FIG. 12 is a graph illustrating a relationship between R_{C} (R=15 mm, λ=1550 nm) (μm) and an outer diameter ratio T (a.u.);

FIG. 13 is a graph illustrating a relationship between ΔJ (%) and Δn×(D−d) (%·μm);

FIG. 14 is a table summarizing preferred ranges and more preferred ranges for each of parameters of an optical fiber;

FIG. 15 is a diagram illustrating examples of various refractive index profiles applicable to the core 10;

FIG. 16 is a diagram illustrating examples of various refractive index profiles applicable to the first cladding 20; and

FIG. 17 is a diagram illustrating examples of various refractive index profiles applicable to the second cladding 30.

### DETAILED DESCRIPTION

### Technical Problem

The inventors found the following problems as a result of examinations on conventional optical fibers.

That is, using the VAD method or the OVD method to provide a glass region to be the second cladding outside the glass region to be the first cladding in a preform manufacturing stage in order to obtain an optical fiber having a W-type refractive index profile would make it possible to reduce the cost as compared with the rod-in collapse method. On the other hand, the optical fiber obtained by drawing the preform has an increased refractive index inside the second cladding, leading to a possibility of deterioration of the transmission loss in the optical fiber in the signal light wavelength. In addition, it is difficult to add sufficient fluorine to the inside of the second cladding (in the vicinity of the interface between the first cladding and the second cladding) by the VAD method or the OVD method, leading to deformation of the refractive index profile inside the second cladding in a protruding shape. The presence of the protrusion appearing in the refractive index profile facilitates higher order modes to remain in the optical fiber, leading to a problem of deterioration of the transmission loss in the obtained optical fiber.

Furthermore, Patent Document 1 describes that suppressing an increase of the relative refractive index difference ΔP of the protrusion appearing in the refractive index profile can suppress an increase in transmission loss. Still, there has been a higher demand for low transmission loss. Since ΔP can vary in the longitudinal direction of the preform, an optical fiber obtained from a region where ΔP is high in the preform would increase the transmission loss (not capable of maintaining high productivity). In addition, it is difficult to control ΔP with high accuracy by the VAD method or the OVD method. Therefore, there is a possibility that ΔP becomes large in conventional optical fiber manufacturing technologies. When ΔP is large, higher order modes tend to remain in the inner region of the second cladding (region corresponding to the protrusion of the refractive index profile) as described above (deteriorating the transmission loss in the optical fiber at the signal light wavelength).

The present disclosure has been made in order to solve the above-described problems, and aims to provide an optical fiber having a structure enabling determination of improvement in transmission loss at a preform stage as compared with a conventional optical fiber.

### Advantageous Effects of Invention

As described above, according to the embodiment of the present disclosure, it is possible to obtain an optical fiber having a sufficiently improved transmission loss as compared with a conventional optical fiber. In addition, since the improvement in transmission loss can be determined at the preform stage, the improvement in optical fiber productivity can be expected.

### Description of Embodiment of Present Invention

Hereinafter, embodiments of the present disclosure will be described individually.

(1) An optical fiber according to an embodiment of the present disclosure includes, in an aspect, a core constituting a W-type refractive index profile, a first cladding, and a second cladding. In addition, the optical fiber further includes a resin coating that integrally covers the core, the first cladding, and the second cladding. The core includes at least a Cl-doped region and has an average refractive index lower than a refractive index of pure silica glass. The first cladding is disposed so as to surround the core. Furthermore, the first cladding contains at least F, and has a refractive index lower than the average refractive index of the core. The second cladding is disposed so as to surround the first cladding, and has a higher refractive index than in the first cladding. The resin coating is disposed so as to surround the second cladding. In particular, an effective area A_{eff} at a wavelength of 1550 nm is 130 μm² or more and 170 μm² or less. A ratio (A_{eff}/λ_{C}) of the effective area A_{eff} to a cutoff wavelength (2 m cutoff wavelength) λ_{C} is 85.0 μm or more. A bending loss of an LP01 mode at a wavelength of 1550 nm and at a bending radius of R15 mm is less than 4.9 dB per 10 turns. The resin coating includes a primary resin layer having at least a Young's modulus of 0.3 MPa or less. Note that the above-described unit of bending loss (dB per 10 turns) means a loss value measured in a state where the mandrel having a predetermined bending radius R is wound as many turns as necessary (for example, 10 turns).

(2) In an aspect of the present disclosure, the second cladding is preferably comprised of pure silica glass or silica glass containing at least F. In particular, forming the second cladding with a pure silica cladding enables reduction of the manufacturing cost. In the present specification, in a configuration with the second cladding which is comprised of silica glass containing at least F, an “inner region” and an “outer region” of the second cladding is defined depending on the shape of the refractive index profile in the second cladding. Specifically, the “inner region” of the second cladding is a region including the vicinity of an interface between the first cladding and the second cladding, and is defined as a position having a first local maximum (refractive index peak) in a refractive index profile in the radial direction of the optical fiber. Furthermore, a position of a local minimum of the refractive index profile following the position of the local maximum is defined as a boundary between the “inner region” and the “outer region”.

(3) In an aspect of the present disclosure, the effective area A_{eff} is preferably 135 μm² or more and 165 μm² or less. Since this case can suppress the nonlinear effect, the span length can be further increased.

(4) In an aspect of the present disclosure, the cutoff wavelength is preferably 1630 nm or less. In this case, it is possible to prevent multimode transmission in a communication wavelength band of C-band or L-band after cable formation (enabling single-mode transmission).

(5) In an aspect of the present disclosure, the lower limit value of the ratio (A_{eff}/λ_{C}) is preferably 85 μm or 95 μm. Furthermore, the upper limit value of the ratio (A_{eff}/λ_{C}) is preferably 120 μm or 130 μm. In this case, the appropriate range of the ratio (A_{eff}/λ_{C}) in the optical fiber is preferably 85 μm or more and 120 μm or less, 85 μm or more and 130 μm or less, 95 μm or more and 120 μm or less, and 95 μm or more and 130 μm or less. Furthermore, the upper limit value of the ratio (A_{eff}/λ_{C}) may be either 120 μm or 130 μm. In particular, in a case where the ratio (A_{eff}/λ_{C}) is 95 μm or more, the transmission loss can be further reduced. Furthermore, in a case where the ratio (A_{eff}/λ_{C}) is 120 μm or less, it is possible to suppress an increase in macrobending loss. In addition, when the ratio (A_{eff}/λ_{C}) is 95 μm or more and 130 μm or less, it is possible to achieve each of suppression of an increase in macrobending loss, suppression of nonlinearity effects, and prevention of multimode transmission in the C-band and L-band communication wavelength bands after cable formation.

(6) In an aspect of the present disclosure, a mode field (hereinafter referred to as “MFD”) diameter of the LP01 mode at a wavelength of 1550 nm is preferably 12.5 μm or more and 14.0 μm or less. This makes it possible to reduce a connection loss between a standard single-mode optical fiber (hereinafter referred to as “SMF”) and the optical fiber of the present disclosure, leading to the reduction in the span loss. Furthermore, in an aspect of the present disclosure, a bending loss of an LP11 mode at a wavelength of 1550 nm and at a bending radius of R40 mm is preferably 0.10 dB per 2 turns or more. In this case, the higher order mode is quickly released even when the bending radius is likely to allow coupling between the higher order mode and the fundamental mode, resulting in suppression of the loss of the fundamental mode due to the coupling between the higher order mode and the fundamental mode.

(7) In an aspect of the present disclosure, a difference between a first caustic radius and a second caustic radius is 0.90 μm or more. The first caustic radius is defined as a caustic radius R_{C} (R=25 mm, λ=1550 nm) of the LP01 mode at a wavelength of 1550 nm and at a bending radius R25 mm and a caustic radius R_{C} (R=15 mm, λ=1550 nm) of the LP01 mode at a wavelength of 1550 nm and at a bending radius R15 mm is 0.90 μm or more. In this case, the bending loss can be controlled to a practical magnitude at the bending radius in actual use.

(8) In an aspect of the present disclosure, R_{C,eff} and ΔD (%) preferably satisfy the following relationship:

R_{C,eff}>1.46+ΔD(%)×1.93(1/%),

wherein the R_{C,eff} is a ratio of the caustic radius R_{C} (R=15 mm, λ=1550 nm) (μm) at a wavelength of 1550 nm and at a bending radius of R15 mm to a mode field diameter (hereinafter referred to as “MFD”) of the LP01 mode at the wavelength of 1550 nm, and the ΔD (%) is a relative refractive index difference between an average refractive index of the first cladding and a maximum refractive index of an inner region in the second cladding.

Satisfying the above relationship makes it possible to reduce the transmission loss and facilitate designing of optical fiber regardless of the presence or absence of a refractive index peak in the inner region of the second cladding. In the present specification, the relative refractive index difference between a region having a refractive index n₁ and a region having a refractive index n₂ is defined by the following formula: |n₁²−n₂²|/2n₁². As the refractive index n₁ of the denominator, a refractive index of 1.45 of pure silica glass can be used approximately.

(9) In an aspect of the present disclosure, as a shape for implementation of all the above aspects, the W-type refractive index profile of the optical fiber preferably satisfies the following relationship:

0.15≤Δn≤0.29;

0.02≤ΔD≤Δn+0.05;

2.0 (μm)≤D/d≤3.7;

2.55≤T≤3.05; and

−0.22≤ΔJ−0.056 (μm⁻¹)×Δn×(D (μm)−d (μm)),

where the Δn is a relative refractive index difference between the average refractive index of the core and the refractive index of the first cladding, the ΔD is a relative refractive index difference between the refractive index of the first cladding and the maximum refractive index in the inner region of the second cladding, the d is a radius of the core, the D is an outer diameter of the first cladding, the T is a ratio of the outer diameter of the second cladding to the outer diameter of the first cladding, and the ΔJ is a relative refractive index difference between the refractive index of the first cladding and a minimum refractive index of the outer region of the second cladding. According to such a refractive index profile, it is possible to satisfy the above-described condition: R_{C, eff}>1.46+ΔD×1.93 (1/%) and to adjust a bending loss of the LP01 mode at a wavelength of 1550 nm and at a bending radius of R15 mm to less than 4.9 dB per 10 turns.

(10) In an aspect of the present disclosure, the resin coating may further include a secondary resin layer surrounding the primary resin layer. Specifically, in an aspect of the present disclosure, the secondary resin layer preferably has a Young's modulus of 800 MPa or more. In this case, micro-bending loss can be suppressed. In one aspect of the present disclosure, an absolute value of the refractive index difference at a wavelength of 546 nm between the primary resin layer and the secondary resin layer is preferably 0.15 or less. In this case, it is possible to suppress an increase in transmission loss due to reflection at an interface between the primary resin and the secondary resin. Furthermore, in one aspect of the present disclosure, an absolute value of a refractive index difference at a wavelength of 546 nm (average refractive index in a case where the refractive index of the outer region varies in the radial direction) between the outer region of the second cladding and the primary resin layer is preferably 0.08 or less. In this case, it is also possible to suppress an increase in transmission loss due to reflection at an interface between the second cladding and the primary resin.

As described above, each aspect listed in [Description of Embodiment of Present Invention] is applicable to all of the remaining aspects or to all combinations of these remaining aspects.

### Details of Embodiment of Present Invention

Specific examples of an optical fiber according to the present invention will be described below in detail with reference to the accompanying drawings. The present invention is not limited to these examples, but is to be indicated by the scope of the claims, and it is intended to include meanings equivalent to the claims and all modifications within the scope. Furthermore, the same reference signs are given to same components and duplicate descriptions will be omitted in the description of the drawings.

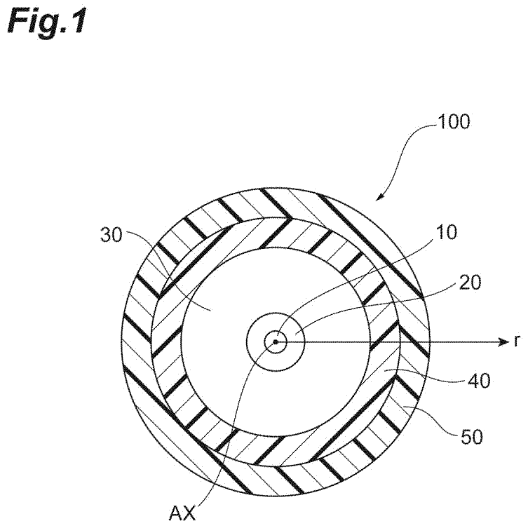

FIG. 1 is a diagram illustrating an example of a cross-sectional structure of an optical fiber according to the present embodiment. That is, an optical fiber 100 includes: a core 10 extending in an optical axis AX (the optical axis AX substantially passes through the center of the cross section of the core 10); first cladding 20 surrounding the core 10; second cladding 30 surrounding the first cladding 20; and a resin coating surrounding the second cladding 30. In the example of FIG. 1, the resin coating includes: a primary resin layer 40 surrounding the second cladding 30; and a secondary resin layer 50 surrounding the primary resin layer 40.

The core 10 is comprised of silica glass which is doped with a refractive index reducer such as F and has a refractive index adjusted to be lower than the refractive index of the pure silica glass (PS). In particular, Cl is doped to at least a part of the core 10. Due to such Cl-doping, there is provided an inclination in a radial direction r in the refractive index profile of the core 10. The first cladding 20 is comprised of silica glass doped with F, and the average refractive index of the first cladding 20 is adjusted to be lower than the average refractive index of the core 10. The second cladding 30 is comprised of pure silica glass or silica glass doped with F, and the refractive index of the second cladding 30 is adjusted to be higher than the average refractive index of the first cladding and to be lower than the average refractive index of the core 10. The first cladding 20 and second cladding 30 with such configuration forms a depressed cladding structure. The depressed cladding structure enables single-mode propagation at a signal light wavelength and achieves low transmission loss.

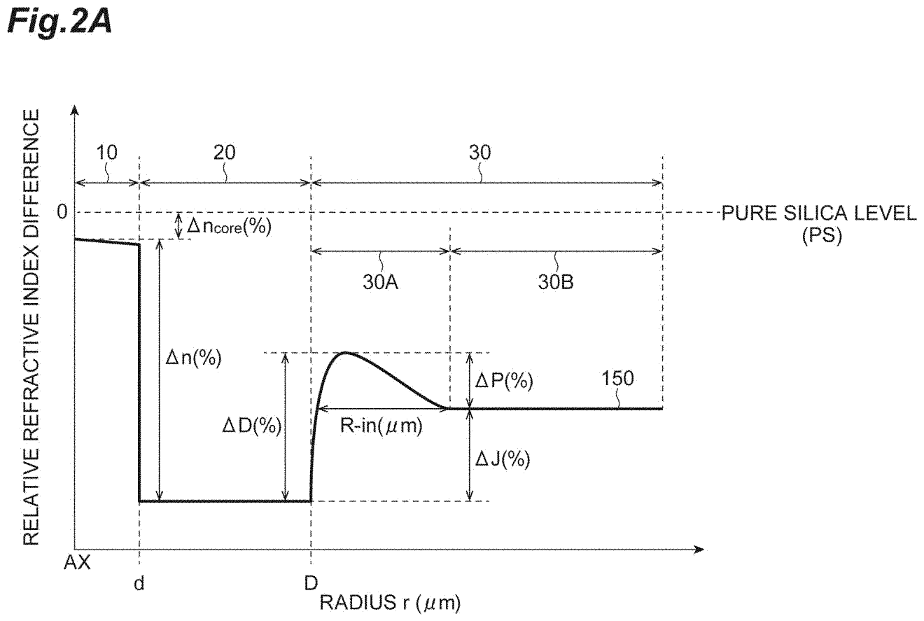

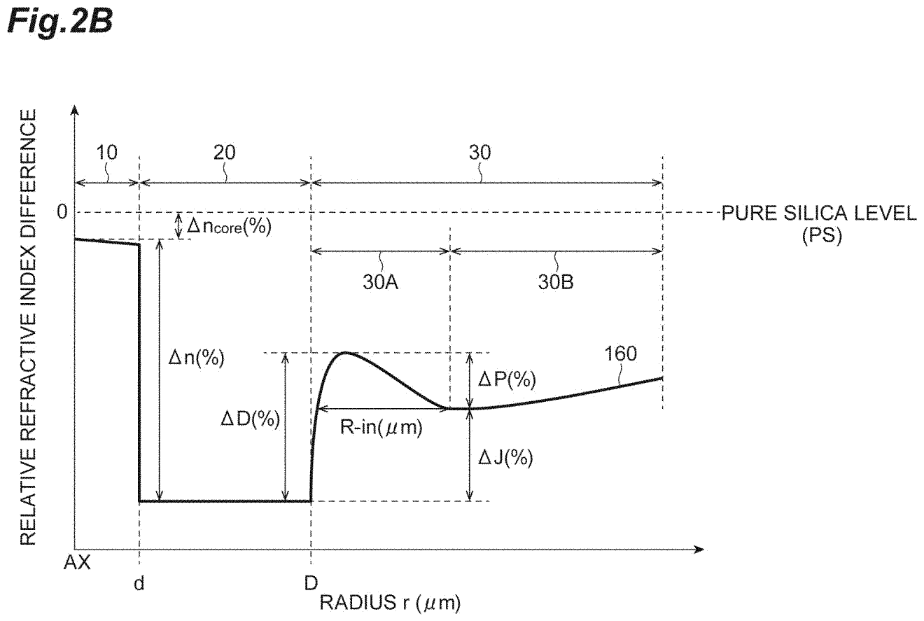

FIG. 2A is a diagram illustrating an example of a refractive index profile of an optical fiber. FIG. 2B is a diagram illustrating another example of a refractive index profile of an optical fiber. In refractive index profiles 150 and 160 respectively illustrated in FIGS. 2A and 2B, the second cladding 30 is comprised of silica glass doped with F, and a remaining region of the second cladding 30 excluding the vicinity of the interface between the first cladding 20 and the second cladding 30 is divided into an inner region 30A and an outer region 30B by positions of the local maximum and the local minimum of the refractive index profiles 150 and 160.

In the refractive index profile 150 illustrated in FIG. 2A, “Δn_{core} (%)” is a relative refractive index difference between the average refractive index of the core 10 and the refractive index of pure silica glass (a pure silica level, hereinafter referred to as “PS”). “d” is radius (μm) of the core 10. “Δn (%)” is a relative refractive index difference between the average refractive index of the core 10 and the average refractive index of the first cladding 20. “D” is the outer radius (μm) of the first cladding 20 (the interface position between the first cladding 20 and the second cladding 30). “ΔD (%)” is a relative refractive index difference between the average refractive index of the first cladding 20 and the maximum refractive index (refractive index peak) of the inner region 30A. “R-in” is a length (μm) of the inner region 30A in the radial direction r of the optical fiber 100. “ΔP (%)” is a relative refractive index difference (a relative refractive index difference at the protrusion in the refractive index profile) between the maximum refractive index of the inner region 30A and the minimum refractive index of the outer region 30B (the local minimum of the refractive index profile 150). “ΔJ (%)” is a relative refractive index difference between the average refractive index of the first cladding 20 and the minimum refractive index of the outer region 30B.

As described above, in the refractive index profile 150 illustrated in FIG. 2A, the second cladding 30 is divided into the outer region 30B having a substantially uniform refractive index in the radial direction r, and the inner region 30A existing in the inner side of the outer region 30B and having a refractive index higher than in the outer region 30B. In the present specification, “substantially uniform” means that the refractive index variation of the outer region 30B in the second cladding 30 in the radial direction r is ±0.01% or less with respect to the average value.

Meanwhile, in the refractive index profile 160 illustrated in FIG. 2B, the definition of the structural parameter of each of parts is similar to the case of the refractive index profile 150 illustrated in FIG. 2A, whereas the profile shape at the outer region 30B is different in the refractive index profile 160 from the case of the refractive index profile 150. That is, the refractive index profile 160 has a shape having a recess in the radial direction r in the second cladding 30. In the refractive index profile 160, a region inside the position of a peak of recess (position at which the refractive index profile 160 takes the local minimum in the second cladding 30) is defined as the inner region 30A and the side outer than this is defined as the outer region 30B. At this time, the relative refractive index difference between the maximum refractive index of the inner region 30A and the minimum refractive index of the outer region 30B is ΔP.

Next, results of examination of a relationship between structural parameters and transmission characteristics in various optical fibers will be described.

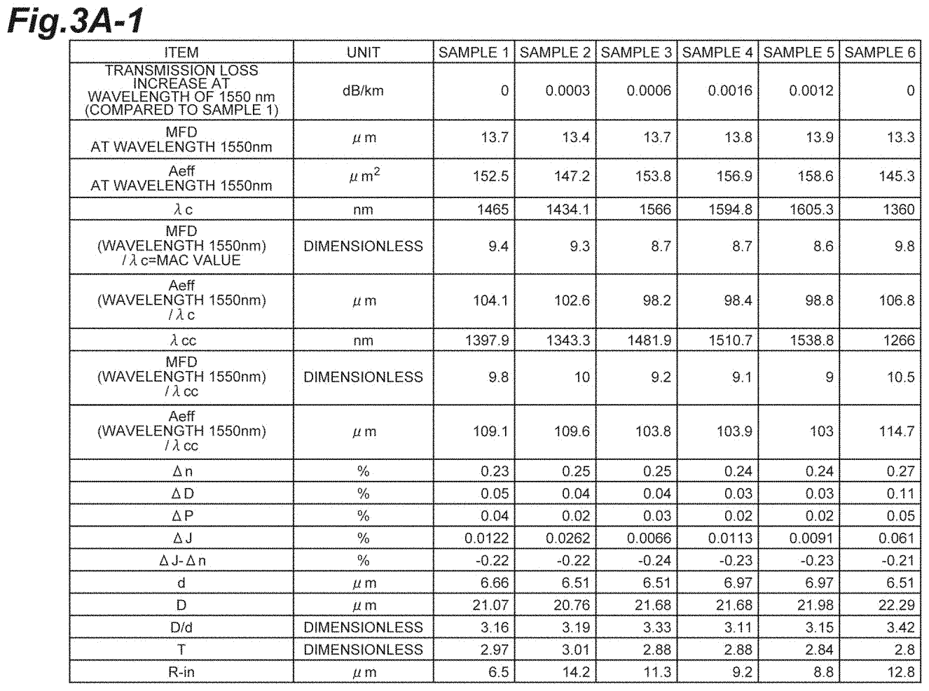

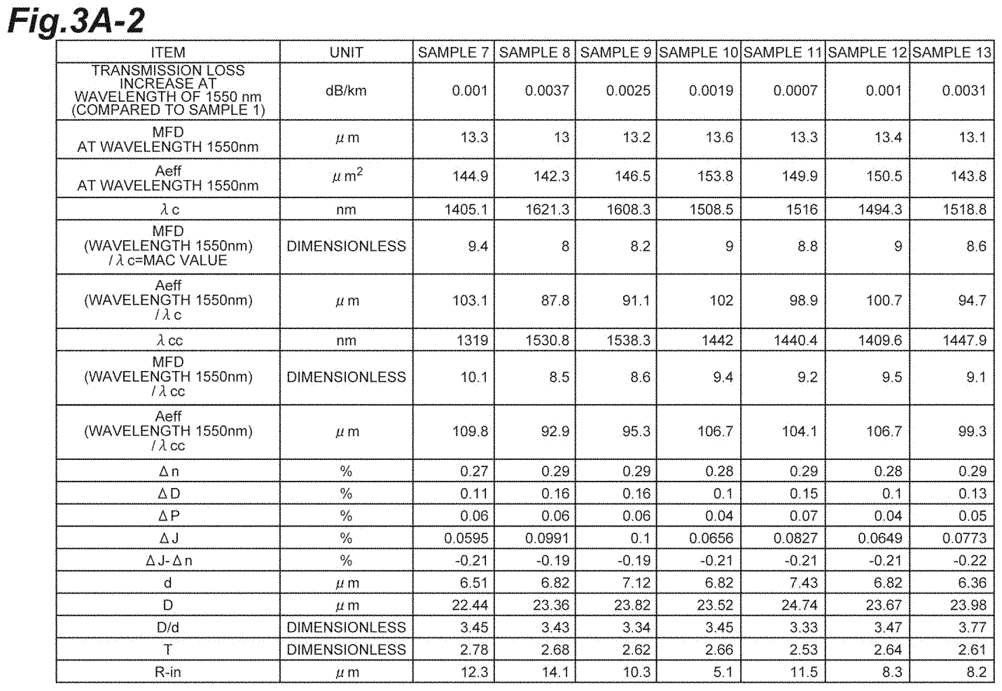

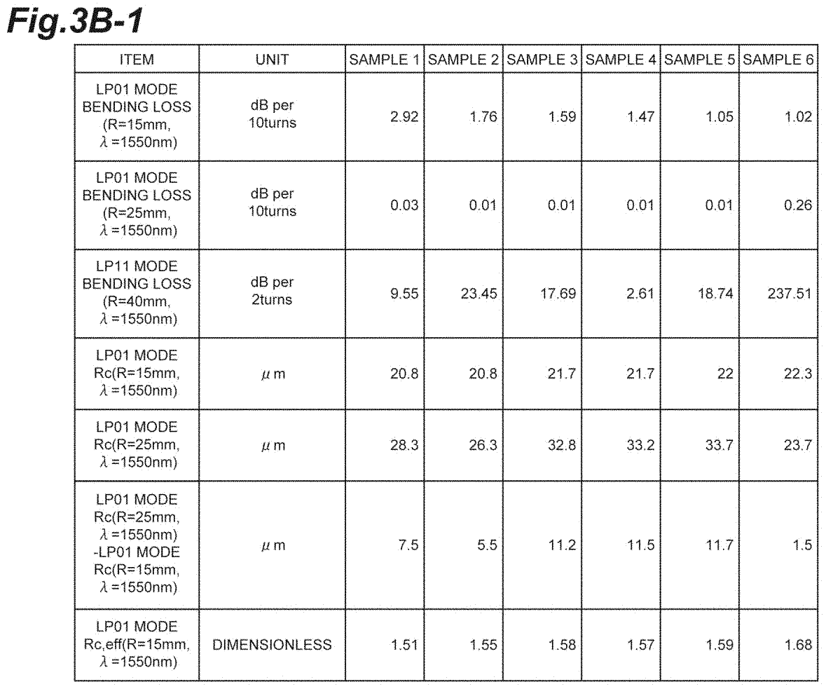

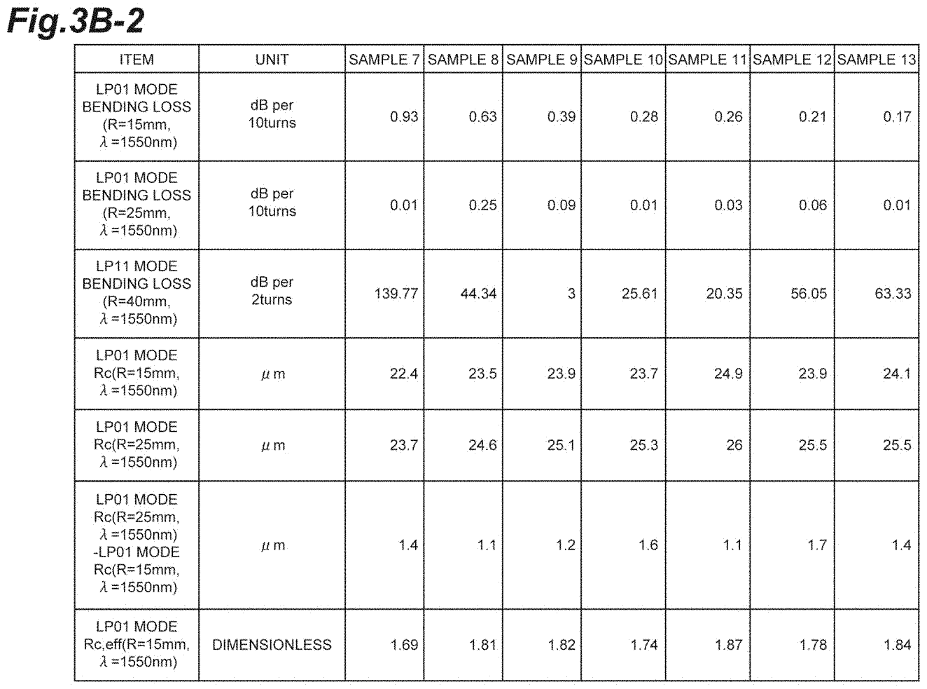

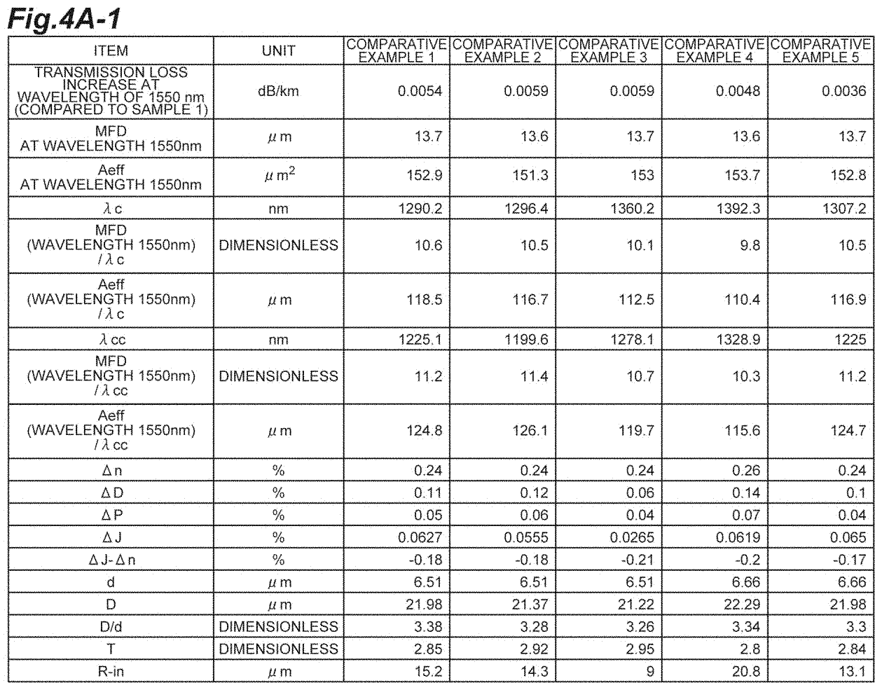

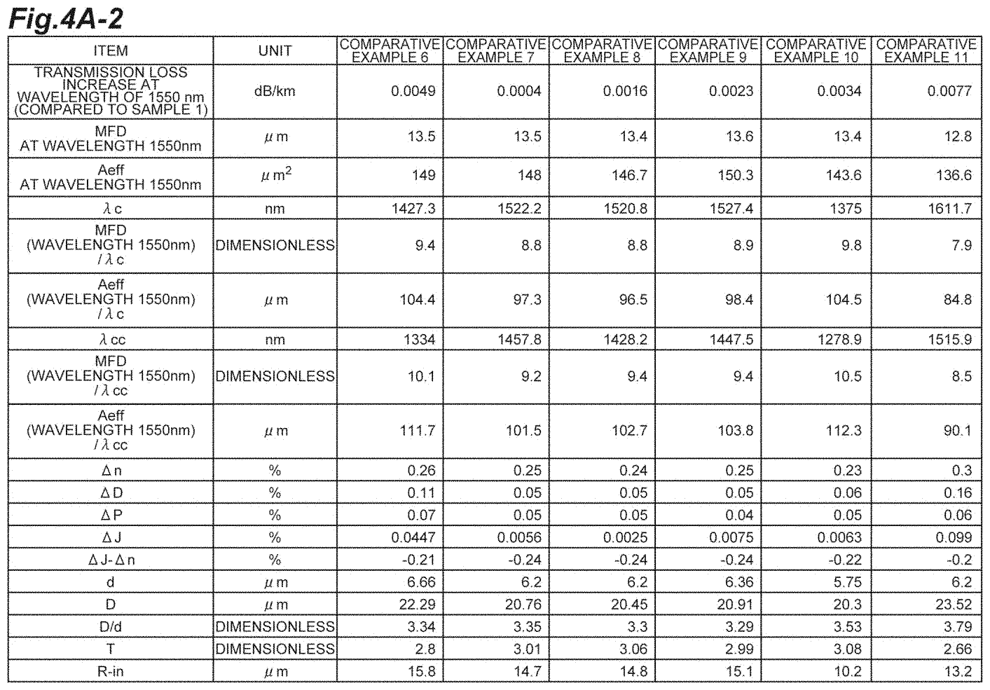

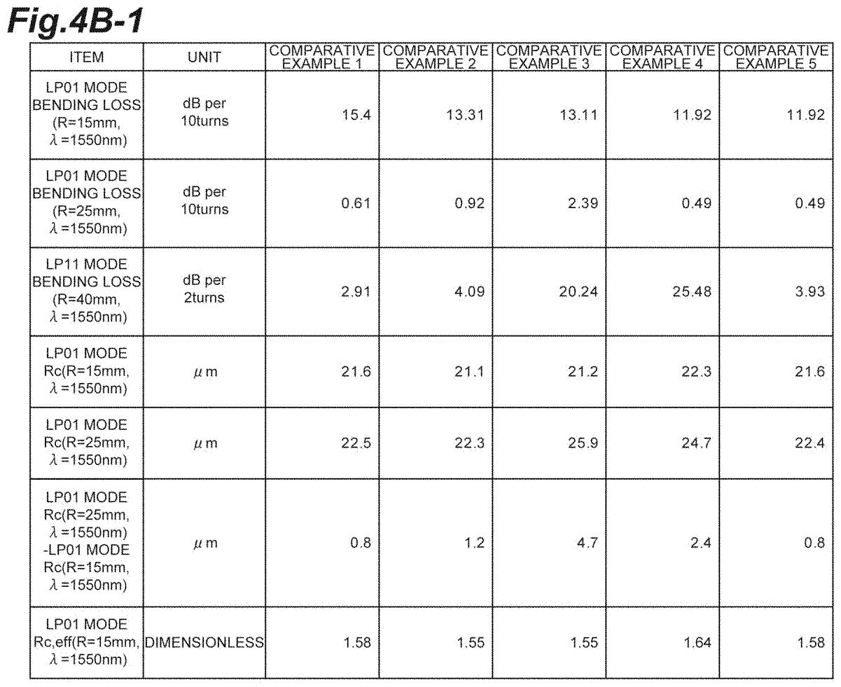

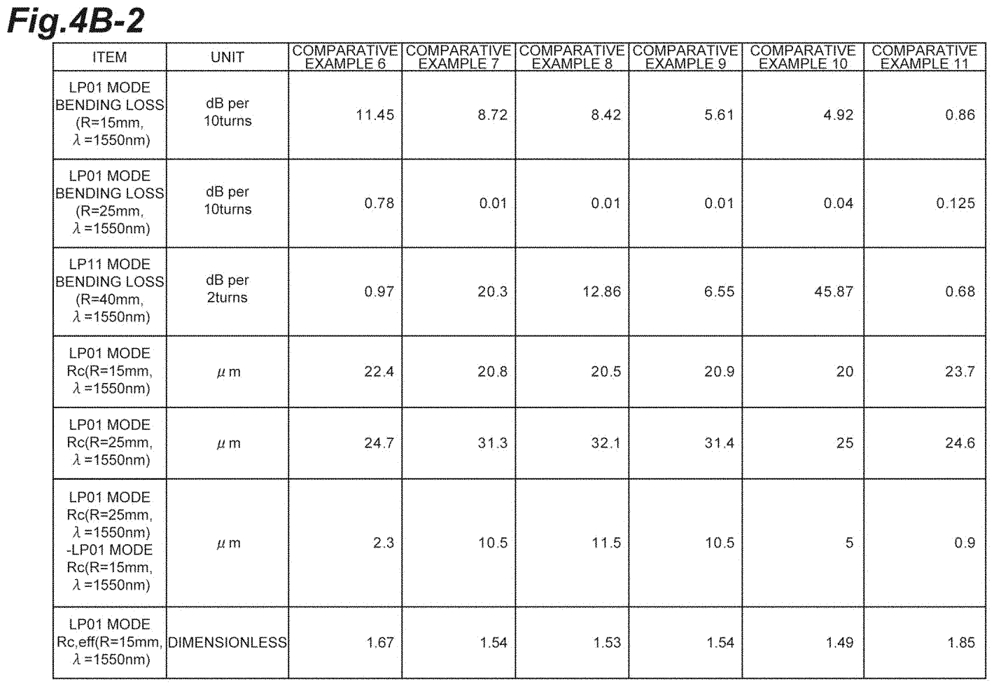

FIGS. 3A-1 and 3A-2 are tables summarizing specifications of the optical fibers according to Samples 1 to 13 of the present embodiment. FIGS. 33-1 and 3B-2 are tables summarizing the bending loss of the optical fibers according to Samples 1 to 13 of the present embodiment. FIGS. 4A-1 and 4A-2 are tables summarizing specifications of the optical fibers according to comparative examples 1 to 11. FIGS. 4B-1 and 4B-2 are tables summarizing the bending loss of the optical fibers according to comparative examples 1 to 11.

The items illustrated in FIGS. 3A-1, 3A-2, 4A-1, and 4A-2 are as follows. That is, “transmission loss increase at wavelength of 1550 nm (compared to Sample 1)” is an increase in loss in each of samples or comparative examples based on the transmission loss of Sample 1 at wavelength of 1550 nm. “MFD at wavelength 1550 nm” is an MFD at a wavelength of 1550 nm. “A_{eff} at wavelength 1550 nm” is an effective area at a wavelength of 1550 nm. “λ_{C}” is a 2 m cutoff wavelength defined in ITU-T G.650.1. “MFD (wavelength 1550 nm)/λ_{C}=MAC value” is a ratio (MAC value) of the MFD at the wavelength of 1550 nm to the 2 m cutoff wavelength λ_{C}. “A_{eff} (wavelength 1550 nm)/λ_{C}” is a ratio of the effective area A_{eff} to the 2 m cutoff wavelength λ_{C}. “λ_{CC}” is a cable cutoff wavelength (22 m cutoff wavelength) defined by ITU-T G.650.1. “MFD (wavelength 1550 nm)/λ_{CC}” is a ratio of MFD at the wavelength of 1550 nm to the cable cutoff wavelength λ_{CC}. “A_{eff} (wavelength 1550 nm)/λ_{CC}” is a ratio of the effective area A_{eff} to the cable cutoff wavelength λ_{CC}. “Δn” is a relative refractive index difference between the average refractive index of the core 10 and the average refractive index of the first cladding 20. “ΔD” is a relative refractive index difference between the average refractive index of the first cladding 20 and the maximum refractive index (refractive index peak) of the inner region 30A. “ΔP” is a relative refractive index difference between the maximum refractive index of the inner region 30A and the minimum refractive index of the outer region 30B (local minimum of the refractive index profile 150). “ΔJ” is a relative refractive index difference between the average refractive index of the first cladding 20 and the minimum refractive index of the outer region 30B. “ΔJ−Δn” is a difference between ΔJ and Δn. “d” is the radius of the core 10. “D” is the outer radius of the first cladding 20. “D/d” is a ratio of the outer radius D of the first cladding 20 to the radius d of the core 10. “T” is the ratio of the outer radius of the first cladding 20 to the outer radius of the second cladding 30. “R-in” is a width of the inner region 30A.

The items illustrated in FIGS. 3B-1, 3B-2, 4B-1, and 4B-2 are as follows. That is, a “LP01 mode bending loss (R=15 mm, λ=1550 nm)” is a bending loss of the LP01 mode at a wavelength of 1550 nm and at a bending radius of 15 mm. The “LP01 mode bending loss (R=25 mm, λ=1550 nm)” is a bending loss of the LP01 mode at a wavelength of 1550 nm and at a bending radius of 25 mm. “LP11 mode bending loss (R=40 mm, λ=1550 nm)” is a bending loss of an LP11 mode at a wavelength of 1550 nm and at a bending radius of 40 mm. “LP01 mode R_{C} (R=15 mm, λ=1550 nm)” is a caustic radius of the LP01 mode at a wavelength of 1550 nm and at a bending radius of 15 mm. “LP01 mode R_{C} (R=25 mm, λ=1550 nm)” is a caustic radius of the LP01 mode at a wavelength of 1550 nm and at a bending radius of 25 mm. “LP01 mode R_{C} (R=25 mm, λ=1550 nm)−LP01 mode R_{C} (R=15 mm, λ=1550 nm)” is a difference between a caustic radius of the LP01 mode at a wavelength of 1550 nm and at a bending radius of 25 mm and a caustic radius of the LP01 mode at a wavelength of 1550 nm and at a bending radius of 15 mm “LP01 mode R_{C,eff} (R=15 mm, λ=1550 nm)” is a value obtained by dividing the caustic radius of the LP01 mode at a wavelength of 1550 nm and at a bending radius of 15 mm to the MFD of the LP01 mode at a wavelength of 1550 nm.

In each of Samples 1 to 11 illustrated in FIGS. 3A-1, 3A-2, 3B-1, and 3B-2, the effective area A_{eff} at a wavelength of 1550 nm is 135 μm² or more and 170 μm² or less, the ratio (A_{eff}/λ_{C}) of the effective area A_{eff} to the cutoff wavelength λ_{C} is 85.0 μm or more, and the bending loss of the LP01 mode at a wavelength of 1550 nm and at a bending radius of R15 mm is less than 4.9 dB per 10 turns. In contrast, in each of comparative examples 1 to 10 illustrated in FIGS. 4A-1, 4A-2, 4B-1, and 4B-2, the bending loss in the LP01 mode at a wavelength of 1550 nm and at a bending radius of R15 mm exceeds 4.98 dB per 10 turns. In comparative example 11, the ratio (A_{eff}/λ_{C}) of the effective area A_{eff} to the cutoff wavelength λ_{C} is less than 85.0 μm.

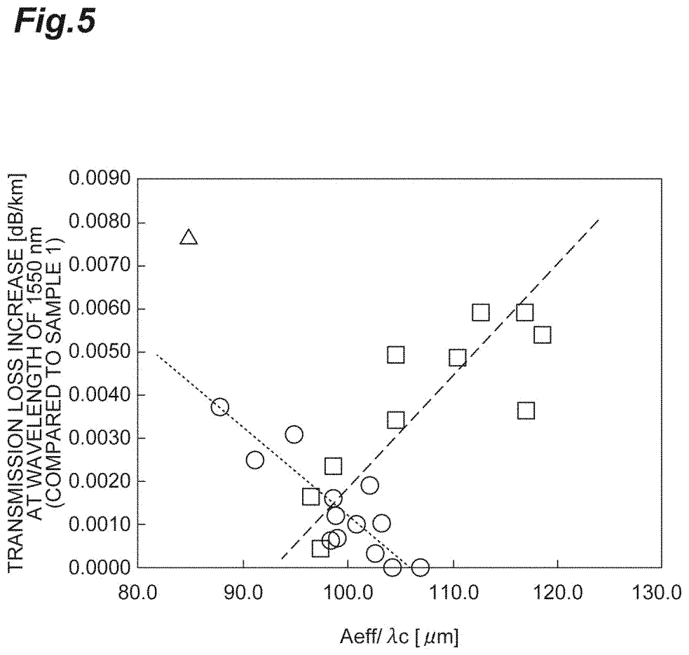

Regarding the optical fiber 100 having the structural parameters and transmission characteristics as described above, a relationship between the transmission loss at the wavelength of 1550 nm and the value A_{eff}/λ_{C} (μm) obtained by dividing the effective area A_{eff} (μm²) of the LP01 mode at the wavelength of 1550 nm by the 2 m cutoff wavelength λ_{C} (μm) will be described with reference to FIG. 5. The 2 m cutoff wavelength is a fiber cutoff wavelength of the LP01 mode defined in ITU-T G.650.1. Note that, in FIG. 5, the vertical axis represents a transmission loss increase (dB/km) at the wavelength of 1550 nm based on the transmission loss of Sample 1. The horizontal axis is A_{eff}/λ_{C} (μm). In addition, the symbol “∘” plotted in FIG. 5 indicates Samples 1 to 13 in which the bending loss of the LP01 mode at a wavelength of 1550 nm with the bending radius of R15 mm (hereinafter referred to as “LP01 mode bending loss (R=15 mm, wavelength λ=1550 nm)” is less than 4.9 dB per 10 turns and the ratio (A_{eff}/λ_{C}) of the effective area A_{eff} to the cutoff wavelength λ_{C} is 85.0 μm or more. The symbol “Δ” indicates comparative example 11 in which the LP01 mode bending loss (R=15 mm, wavelength λ=1550 nm) is less than 4.9 dB per 10 turns, and the ratio (A_{eff}/λ_{C}) is less than 85.0 μm. The symbol “□” indicates comparative examples 1 to 10 in which the LP01 mode bending loss (R=15 mm, wavelength λ=1550 nm) is 4.9 dB per 10 turns, or more.

As observed in FIG. 5, when the LP01 mode bending loss (R=15 mm, wavelength λ=1550 nm) is less than 4.9 dB per 10 turns and the ratio A_{eff}/λ_{C} is 85.0 μm or more (symbol “∘”), the transmission loss increase with respect to the change in the ratio A_{eff}/λ_{C} is more gradual than the transmission loss increase when the LP01 mode bending loss (R=15 mm, λ=1550 nm) is 4.9 dB per 10 turns, or more (symbol “□”). Since the transmission loss is less likely to change due to changes in the effective areas A_{eff} and λ_{C} attributed to structural fluctuations in the longitudinal direction of the optical fiber, it is possible to produce an optical fiber with small variations in the transmission loss in the longitudinal direction.

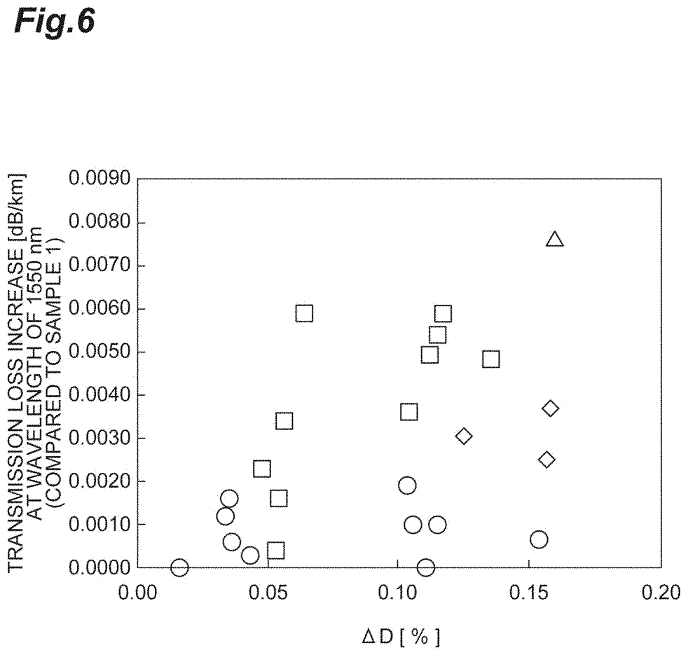

FIG. 6 is a graph illustrating a relationship between a transmission loss increase (dB/km) at a wavelength of 1550 nm and ΔD (%) based on the transmission loss of Sample 1. The symbol “∘” plotted in FIG. 6 indicates Samples 1 to 7 and Samples 10 to 12 in which the LP01 mode bending loss (R=15 mm, wavelength λ=1550 nm) is less than 4.9 dB per 10 turns, and the ratio (A_{eff}/λ_{C}) is 95.0 μm or more. The symbol “Δ” indicates comparative example 11 in which the LP01 mode bending loss (R=15 mm, wavelength λ=1550 nm) is less than 4.9 dB per 10 turns, and the ratio (A_{eff}/λ_{C}) is less than 85.0 μm. “⋄” (open diamond) indicates Samples 8, 9, and 13 in which the LP01 mode bending loss (R=15 mm, wavelength λ=1550 nm) is less than 4.9 dB per 10 turns, and the ratio (A_{eff}/λ_{C}) is 85.0 μm or more and less than 95 μm. The symbol “□” indicates comparative examples 1 to 10 in which the LP01 mode bending loss (R=15 mm, wavelength λ=1550 nm) is 4.9 dB per 10 turns, or more.

As observed in FIG. 6, when the LP01 mode bending loss (R=15 mm, wavelength λ=1550 nm) is less than 4.9 dB per 10 turns and the ratio A_{eff}/λ_{C} is 85.0 μm or more (symbol “∘” and symbol “⋄”), a change in the transmission loss increase with respect to the change in ΔD is more gradual than the transmission loss increase when the LP01 mode bending loss (R=15 mm, λ=1550 nm) is 4.9 dB per 10 turns, or more (symbol “□”). That is, even when the amount of F doped to the second cladding 30 is small (even when ΔD is large), it would be possible to keep the transmission loss increase within a practically acceptable range (the manufacturing cost can be reduced). In addition, when the LP01 mode bending loss (R=15 mm, λ=1550 nm) is less than 4.9 dB per 10 turns and the ratio (A_{eff}/λ_{C}) is 95.0 μm or more (symbol “∘”), it is possible to suppress the transmission loss increase (compared to Sample 1) to 0.002 dB/km or less regardless of the magnitude of ΔD.

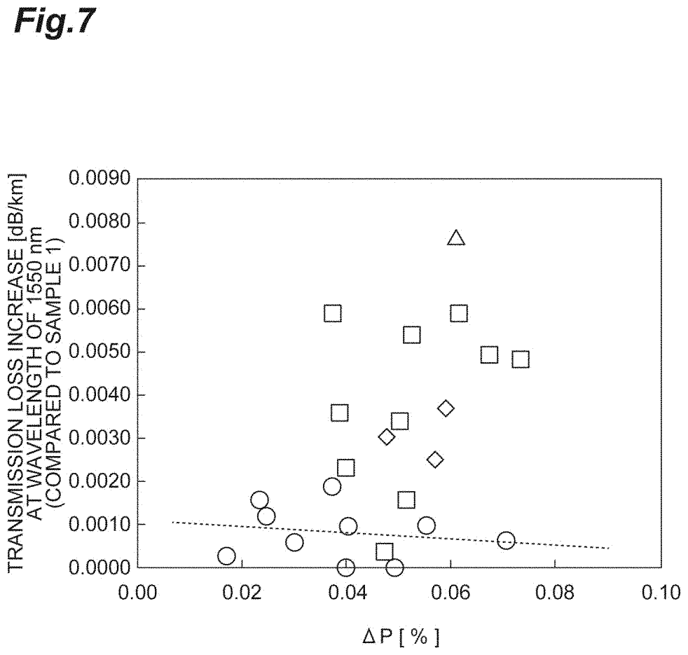

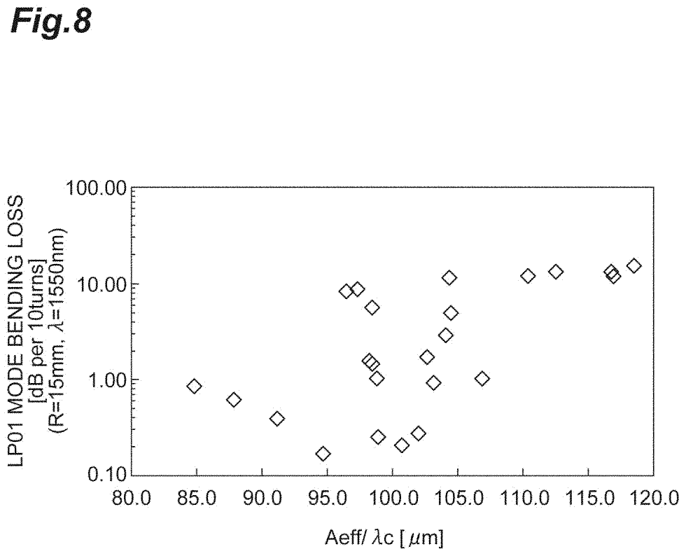

FIG. 7 is a graph illustrating a relationship between a transmission loss increase (dB/km) at a wavelength of 1550 nm and ΔP (%) based on the transmission loss of Sample 1. Note that the symbol “∘” plotted in FIG. 7 indicates a case of Samples 1 to 7 and Samples 10 to 12 in which the LP01 mode bending loss (R=15 mm, wavelength λ=1550 nm) is less than 4.9 dB per 10 turns and the ratio (A_{eff}/λ_{C}) is 95.0 μm or more. The symbol “Δ” indicates comparative example 11 in which the LP01 mode bending loss (R=15 mm, wavelength λ=1550 nm) is less than 4.9 dB per 10 turns, and the ratio (A_{eff}/λ_{C}) is less than 85.0 μm. “⋄” (open diamond) indicates Samples 8, 9, and 13 in which the LP01 mode bending loss (R=15 mm, wavelength λ=1550 nm) is less than 4.9 dB per 10 turns, and the ratio (A_{eff}/λ_{C}) is 85.0 μm or more and less than 95 μm. The symbol “□” indicates comparative examples 1 to 10 in which the LP01 mode bending loss (R=15 mm, wavelength λ=1550 nm) is 4.9 dB per 10 turns, or more. Furthermore, FIG. 8 is a graph illustrating a relationship between a bending loss of the LP01 mode (dB per 10 turns) and A_{eff}/λ_{C} (μm) at a wavelength of 1550 nm with the bending radius R set to 15 mm. Note that FIG. 8 includes plots of Samples 1 to 13 and comparative examples 1 to 11, although they are partially overlapped in display.

As observed in FIG. 7, when the LP01 mode bending loss (R=15 mm, λ=1550 nm) is less than 4.9 dB per 10 turns, and the ratio (A_{eff}/λ_{C}) is 95.0 μm or more (symbol “∘”), it is possible to suppress the transmission loss increase (compared to the Sample 1) to 0.002 dB/km or less regardless of the magnitude of ΔP. In order to improve the signal-to-noise ratio in an optical transmission system that applies an optical fiber as a transmission path for transmitting signal light, the optical fiber is required to suppress nonlinearity as well as achieving low loss. Therefore, having a large effective area A_{eff} of the optical fiber makes it possible to improve the nonlinearity of the optical fiber. On the other hand, it is known that having an excessively large effective area A_{eff} would increase the micro-bending loss. Therefore, it is preferable to set the effective area A_{eff} to be 130 μm² or more and 170 μm² or less. It is more preferable to set the effective area A_{eff} to 135 μm² or more and 165 μm² or less. The 2 m cutoff wavelength is preferably 1630 nm or less. In this case, it is possible to prevent occurrence of multimode transmission in a C-band communication wavelength band and an L-band communication wavelength band when the optical fiber is formed into a cable.

The ratio (A_{eff}/λ_{C}) is a physical quantity linked to a V parameter (V number) representing the magnitude of optical confinement in the core, and thus has a correlation with the bending loss. As observed in FIG. 8, the bending loss increases as the ratio (A_{eff}/λ_{C}) increases. Therefore, the ratio (A_{eff}/λ_{C}) is preferably set to a value not too large, for example, 120 μm or less is preferable. More preferably, the ratio (A_{eff}/λ_{C}) is set to be 110 μm or less, still more preferably 105 μm or less. Note that the bending loss of the LP01 mode obtained at a wavelength of 1550 nm and at a betiding radius of R15 mm is about 0.1 dB per 10 turns. In addition, setting the value (A_{eff}/λ_{CC}) obtained by dividing the effective area A_{eff} by 22 m cutoff wavelength λ_{CC} (μm) to 95 μm or more and 130 μm or less makes it possible to suppress nonlinearity and prevent multimode transmission in communication wavelength bands such as the C-band or the L-band. Here, the 22 m cutoff wavelength is a cable cutoff wavelength of the LP01 mode defined in ITU-T G.650.1.

Having capability of predicting the ratio (A_{eff}/λ_{C}) and a value of the LP01 mode bending loss (R=15 mm, λ=1550 nm) in the state of preform makes it possible to select, before the drawing process, a preform in which the transmission loss would increase or a preform in which transmission loss is likely to vary in the longitudinal direction. This makes it possible to reduce the manufacturing cost. It is well known that measuring the refractive index profile in the radial direction from the center of the preform at a point of completion of the preform and then performing numerical calculation by a Finite Element Method (FEM) based on the refractive index profile will enable estimation of A_{eff} and λ_{C}. That is, the ratio (A_{eff}/λ_{C}) can be easily predicted at the stage of preform. In addition, in a case where it can be predicted that the LP01 mode bending loss (R=15 mm, λ=1550 nm) will be 4.9 dB per 10 turns, or more, or less than this, it is possible, using FIG. 5, to predict a value of the transmission loss increase (compared to Sample 1) or predict whether the transmission loss is likely to vary in the longitudinal direction of the fiber. In particular, when the LP01 mode bending loss (R=15 mm, λ=1550 nm) is less than 4.9 dB per 10 turns, and the ratio (A_{eff}/λ_{C}) is 95.0 μm or more as described above, it is possible to suppress the transmission loss increase (compared to Sample 1) to 0.002 dB/km or less regardless of the magnitude of ΔP. With this configuration, even when ΔP varies in the longitudinal direction of the preform, it is possible to predict before the drawing process whether the transmission loss increase (compared to Sample 1) is 0.002 dB/km or less. That is, it is possible to prevent a defective preform, which is expected to have a large transmission loss increase, from being transferred to the drawing process. As a result, it is possible to suppress an increase in manufacturing cost.

Note that, in the bending loss prediction, which typically uses the ratio (A_{eff}/λ_{C}), it is not easy to perform prediction, as illustrated in FIG. 8, because of large variation while there is a certain correlation in the LP01 mode bending loss (R=15 mm, λ=1550 nm) with respect to the ratio (A_{eff}/λ_{C}). Regarding this problem, there is a value referred to as a caustic radius as a parameter physically related to the bending loss of the optical fiber more closely than the ratio (A_{eff}/λ_{C}).

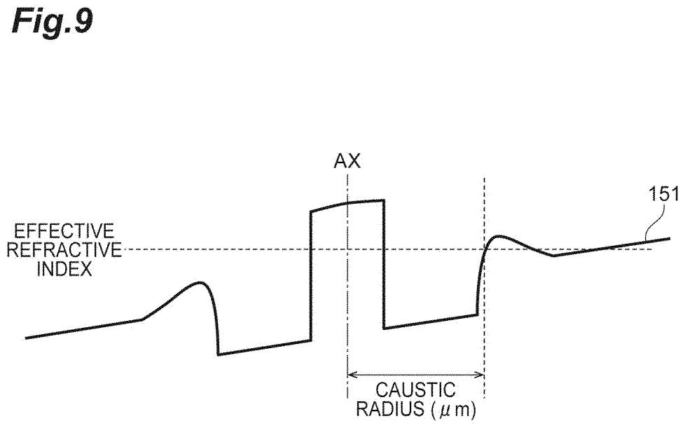

FIG. 9 is a graph illustrating a profile 151 of an equivalent refractive index for analyzing the propagation of light when a certain radius of bending is applied to an optical fiber with the refractive index profiles 150 and 160 respectively illustrated in FIGS. 2A and 2B. In the profile 151 of an equivalent refractive index, the refractive index at each of positions corresponding to the outside of the optical fiber bending is high, while the refractive index at each of positions corresponding to the inside is low. With the use of the equivalent refractive index, the behavior of light propagating in a bent optical fiber can be replaced with the behavior of light propagating in a straight optical fiber for analysis. In FIG. 9, the effective refractive index level of the LP01 mode at a certain wavelength λ is also indicated by a broken line. The caustic radius is a distance from a center position of the optical fiber to a position where the equivalent refractive index and effective refractive index are equal to each other in the equivalent refractive index profile in radial direction of the optical fiber parallel to the bending radius of the optical fiber to which a certain radius of bending has been applied.

Here, the effective refractive index n_{eff}(λ) of the LP01 mode at the wavelength λ is a value obtained by dividing a propagation constant of the LP01 mode at the wavelength λ when the optical fiber is not bent, by the wave number at the wavelength λ. Furthermore, the equivalent refractive index profile n_{bend} (R, λ, r, θ) of the optical fiber is defined as the following Formula (1):

$${n}_{bend} ( R , λ , r , θ ) = n ( λ , r ) ( 1 + \frac{r \cdot cos θ}{R} ) , \qquad ( 1 )$$

where the n(λ, r) is the refractive index profile in the optical fiber cross section at the wavelength λ, and the R (mm) is the bending radius.

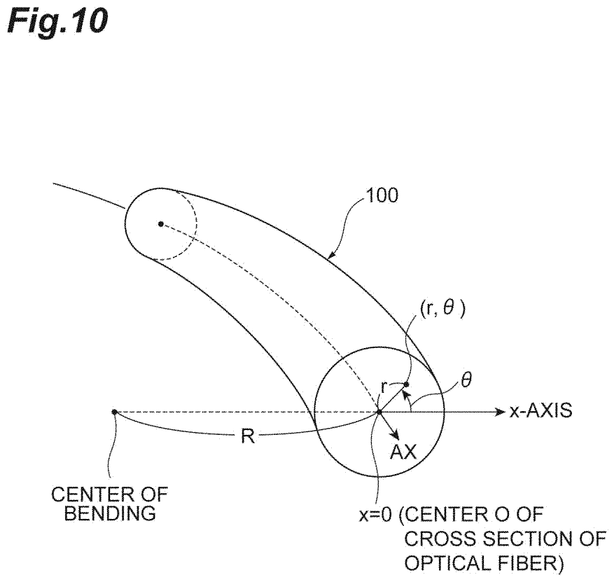

Furthermore, FIG. 10 is a diagram illustrating each of parameters of an optical fiber. r (mm) is a distance from the optical fiber center position (position intersecting the optical axis AX) to a certain point in a cross section of the optical fiber. A straight line connecting the center position of the bending radius and the optical fiber center position is defined as the x-axis, the optical fiber center position is defined as x=0, and a direction from the center position of the bending radius toward the optical fiber center position is defined as a positive direction. At this time, θ is an angle formed by a line segment connecting a certain point in the cross section of the optical fiber to the optical fiber center position and a half line defined by a region where x is 0 or more.

In the following, among the values on the x-axis where the equivalent refractive index n_{bend} (R, λ, r, θ) of the optical fiber is equal to the effective refractive index n_{eff} (λ) of the LP01 mode in a case where θ=0 (that is, within a region satisfying x≥0 on the x-axis), a value on the x-axis satisfying the following Formula (2):

n_{bend}(R,λ,0.95x<r<0.99x,0)<n_{bend}(R,λ,1.01x<r<1.05x,0) (2)

will be defined as a caustic radius Rc (R, λ) at a wavelength λ when the optical fiber is bent at a bending radius R. In a case where a plurality of such Rc (R, λ) exists, the smallest value among these will be adopted.

Note that light existing outside the caustic radius in the cross section of the optical fiber is emitted to the outside of the optical fiber, resulting in bending loss (refer to Patent Document 2).

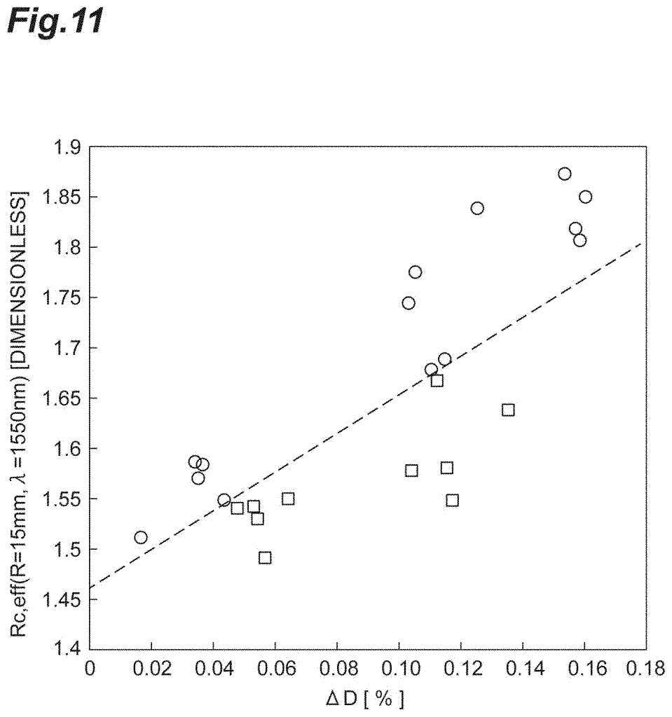

FIG. 11 is a graph illustrating a relationship between R_{C,eff} (R=15 mm, λ=1550 nm) and ΔD (%); Note that R_{C,eff} is a value (μm) obtained by dividing the caustic radius R_{C} (R=15 mm, λ=1550 nm) at a wavelength of 1550 nm with the bending radius of R15 mm by the mode field diameter of the LP01 mode at the wavelength of 1550 nm. The symbol “∘” plotted in FIG. 11 indicates Samples 1 to 13 and comparative example 11 in which the LP01 mode bending loss (R=15 mm, wavelength λ=1550 nm) is less than 4.9 dB per 10 turns, and the symbol “□” indicates comparative examples 1 to 10 in which the LP01 mode bending loss (R=15 mm, wavelength λ=1550 nm) is 4.9 dB per 10 turns, or more. The broken line illustrated in FIG. 11 illustrates R_{C,eff} (R=15 mm, =1550 nm)=1.46+ΔD×1.93 (1/%).

As observed in FIG. 11, when R_{C,eff}(R=15 mm, λ=1550 nm)>1.46+ΔD×1.93 (1/%) is established, the LP01 mode bending loss (R 15 mm, wavelength λ=1550 nm) is less than 4.9 dB per 10 turns. In contrast, when R_{C,eff} (R=15 mm, =1550 nm)≤1.46+ΔD×1.93 (1/%) is established, the LP01 mode bending loss (R=15 mm, wavelength λ=1550 nm) is 4.9 dB per 10 turns, or more.

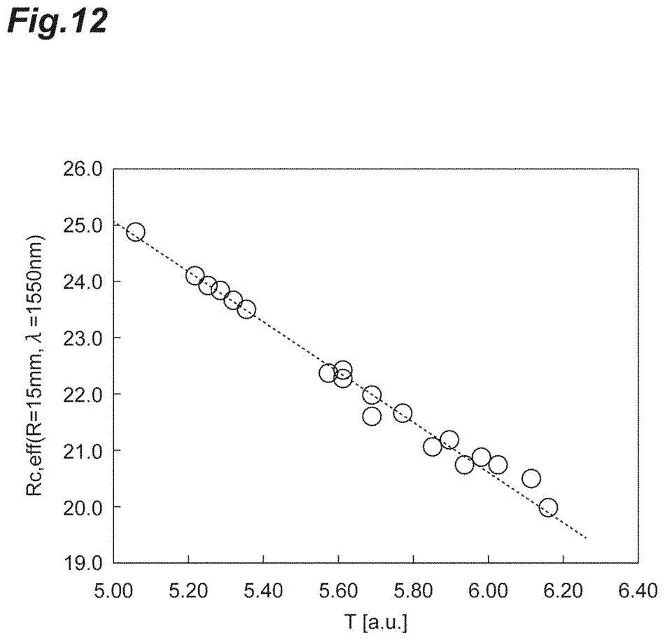

FIG. 12 is a graph illustrating a relationship between R_{C} (R=15 mm, λ=1550 nm) (μm) and an outer diameter ratio T (a.u.). Note that R_{C} (R=15 mm, λ=1550 nm) is a caustic radius at a wavelength of 1550 nm and at a bending radius of R15 mm, and an outer diameter ratio T is a ratio of an outer radius of the second cladding 30 (outer radius of the optical fiber 100) to the outer radius of the first cladding 20. FIG. 8 includes plots of Samples 1 to 13 and comparative examples 1 to 11, although they are partially overlapped in display.

As observed in FIG. 12, there is a high correlation between R_{C} (R=15 mm, λ=1550 nm) and the ratio T. This ratio T is a parameter substantially matching the ratio of the outer diameter of the preform (outer radius of the region corresponding to the second cladding 30) to the outer diameter (or outer radius) of the region corresponding to the first cladding 20 in the state of preform. Therefore, R_{C} (R=15 mm, =1550 nm) can be estimated from a refractive index profile in the radial direction from the center of the preform at a point where the preform is completed.

Note that MFD can be predicted by numerical calculation by a Finite Element Method (FEM) based on the refractive index profile. Therefore, it is possible to predict whether the LP01 mode bending loss (R=15 mm, λ=1550 nm) will be 4.9 dB per 10 turns, or more, or less than this, at the completion of the preform.

Moreover, in the repeater in an optical submarine cable system, a single-mode fiber compliant with ITU-T G.652 is typically used as a feedthrough. Therefore, when the MFD of the LP01 mode at the wavelength of 1550 nm is 12.5 μm or more and 14.0 μm or less, it is possible to reduce the fusion loss with the single-mode fiber compliant with ITU-T G.652, resulting in the reduction of span loss in the optical submarine cable system.

Furthermore, the higher order mode tends to remain in the protrusion corresponding to the inner region 30A out of the refractive index profile of the second cladding 30, and thus, the transmission loss increase is considered to be caused by interaction between the LP01 mode, which is the fundamental mode, and the higher order mode. The magnitude of LP01 mode bending loss (R=15 mm, λ=1550 nm) is considered to be related to the difference in the effective refractive index between the LP01 mode and the higher order mode. Therefore, reducing the LP01 mode bending loss (R=15 mm, λ=1550 nm) would increase the difference in effective refractive index between the LP01 mode and the higher order mode. This makes it possible to reduce the coupling coefficient from the LP01 mode to the higher order mode even when the protrusion is large. From this, it is considered that a transmission loss increase can be suppressed. Furthermore, when the bending loss of the LP11 mode (R=40 mm, λ=1550 nm) is 0.10 dB per 2 turns, or more, even when the light is coupled from the LP01 mode to the higher order mode, the higher order mode light will immediately be emitted to the outside of the optical fiber (due to attenuation), making it possible to suppress the interaction between the LP01 mode and the higher order mode. Preferably, the bending loss of the LP11 mode (R=40 mm, λ=1550 nm) is 0.50 dB per 2 turns, or more, and more preferably, 1.00 dB per 2 turns, or more.

When an optical fiber is actually used in a submarine fiber system, the bending diameter is 50 mm or more even if it is set small (Patent Document 2 described above). When R_{C} (R=25 mm, λ=1550 nm)−R_{C} (R=15 mm, λ=1550 nm) is large, it is possible to set the LP01 mode bending loss (R=25 mm, λ=1550 nm) to be able to withstand practical use. Specifically, when R_{C} (R=25 mm, λ=1550 nm)−R_{C} (R=15 mm, λ=1550 nm) is 0.90 μm or more, and LP01 mode bending loss (R=15 mm, λ=1550 nm) is less than 4.9 dB per 10 turns, the LP01 mode bending loss (R=25 mm, λ=1550 nm) can be set to less than 0.5 dB per 10 turns. Furthermore, when R_{C} (R=25 mm, λ=1550 nm)−R_{C} (R=15 mm, λ=1550 nm) is 1.60 μm or more, and LP01 mode bending loss (R=15 mm, λ=1550 nm) is less than 4.9 dB per 10 turns, the LP01 mode bending loss (R=25 mm, λ=1550 nm) can be set to less than 0.2 dB per 10 turns.

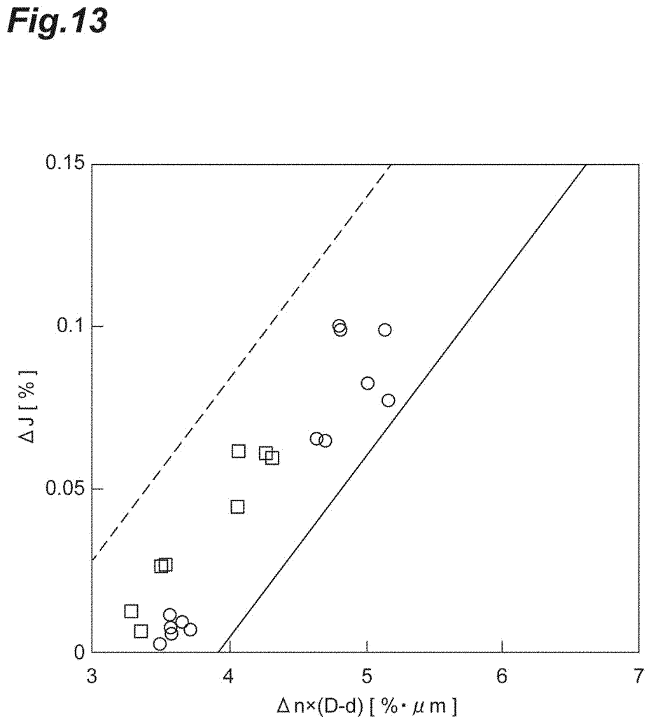

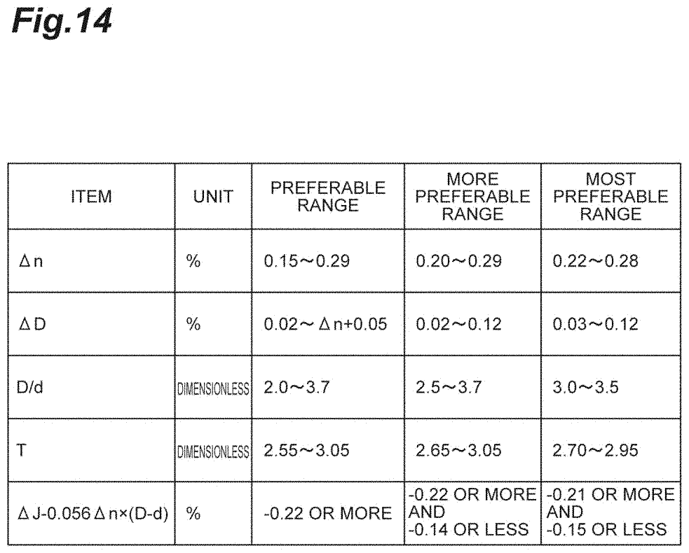

FIG. 13 is a graph illustrating a relationship between ΔJ (%) and Δn×(D−d) (%·μm). Note that the symbol “∘” plotted in FIG. 13 indicates Samples 1, 2, 6, and 7, and comparative example 3 to 6 and comparative example 10 in which the cutoff wavelength λ_{C} is 1300 nm or more and 1490 nm or less. The symbol “□” indicates Samples 3 to 5, Samples 8 to 13, comparative examples 7 to 9, and comparative example 11 in which the cutoff wavelength λ_{C} is 1490 nm or more and 1630 nm or less. The broken line in FIG. 13 represents a straight line given by ΔJ (%)=0.056 (μm⁻¹)×Δn×(D (μm)−d (μm))−0.14, and the solid line represents a straight line given by ΔJ (%)=0.056 (μm⁻¹)×Δn×(D (μm)−d (μm))−0.22. FIG. 14 is a table summarizing preferred ranges and more preferred ranges for each of parameters of the optical fiber.

In FIG. 13, the boundary of the plot region can be approximated by a straight line with a slope of 0.056 (μm⁻¹), and that shorter the λ_{C}, the greater an intercept tends to be. The intercept (that is, ΔJ−0.056 (μm⁻¹)×Δn×(D (μm)−d (μm))) is preferably −0.22% or more and −0.14% or less, and more preferably, −0.21% or more and −0.15% or less. The profile range illustrated in FIG. 14 can satisfy R_{C,eff} (R=15 mm, λ=1550 nm)≥1.46+ΔD (%)×1.93 (1/%).

Next, in a fiber state (state having a cross-sectional structure illustrated in FIG. 1), it is preferable that the primary resin layer 40 has a Young's modulus of 0.3 MPa or less and that the secondary resin layer 50 has a Young's modulus of 800 MPa or more. Furthermore, it is preferable that the primary resin layer has a Young's modulus of 0.2 MPa or less or 0.1 MPa or less and that the secondary resin layer has a Young's modulus of 1000 MPa or more. In this case, it is also possible to have an effect of suppressing an optical loss, referred to as a micro-bending loss, caused by random directional bending in the fiber, which is mainly generated when the fibers are formed into a cable.

In quality inspection of manufactured optical fibers, first measuring the LP01 mode bending loss (R=15 mm, λ=1550 nm), the effective area A_{eff}, and the cutoff wavelength λ_{C} enables determination of whether the transmission loss has increased. Therefore, it is possible to discriminate an optical fiber in which the transmission loss is considered to have increased and an optical fiber having no transmission loss increase without measuring the transmission loss (facilitating manufacturing management). Although it is efficient to wrap the fiber around the mandrel in measuring the LP01 mode bending loss, there is a possibility that micro-bending loss would be induced by lateral pressure when the fiber is wrapped around the mandrel, resulting in a measurement value greater than an actual value. This might lead to false determination, that is, an optical fiber that has no transmission loss increase might be determined to have a transmission loss increase. Also from this viewpoint, it is preferable that the primary resin layer has a Young's modulus of 0.3 MPa or less and that the secondary resin layer has a Young's modulus of 800 MPa or more in the fiber state. Furthermore, it is preferable that the primary resin layer has a Young's modulus of 0.2 MPa or less and that the secondary resin layer has a Young's modulus of 1000 MPa or more.

As described in R. Morgan et al. Opt. Lett. Vol. 15, 947-949 (1990), a difference in the refractive index between the second cladding 30 and the primary resin layer 40 surrounding the second cladding 30 causes occurrence of Fresnel reflection at the boundary between the second cladding 30 and the primary resin layer 40. In this case, it is known that there is a whispering gallery mode phenomenon in which light coupled from the LP01 mode to a higher order mode is reflected and this reflected light is coupled again to the LP01 mode. This is one of the causes of a transmission loss increase at a wavelength of 1550 nm. In order to suppress the whispering gallery mode phenomenon, it is important to suppress an increase in the refractive index difference between the outer region 30B of the second cladding 30 and the primary resin layer 40. Specifically, the absolute value of the refractive index difference between the refractive index of the outer region 30B of the second cladding 30 and the refractive index of the primary resin layer 40 at a wavelength of 546 nm is preferably 0.08 or less. It is more preferable that the value obtained by subtracting the refractive index (average refractive index when the refractive index of the outer region varies in the radial direction r) of the outer region 30B of the second cladding 30 from the refractive index of the primary resin layer 40 at a wavelength of 546 nm is 0 or more and 0.06 or less.

Furthermore, Fresnel reflection due to the difference in the refractive index between the primary resin layer 40 and the secondary resin layer 50 surrounding the primary resin layer 40 can occur (whispering gallery mode phenomenon can occur) at the interface of these layers. Therefore, it is desirable that the difference in refractive index between the primary resin layer 40 and the secondary resin layer 50 is also small. Specifically, the absolute value of the refractive index difference at a wavelength of 546 nm between the primary resin layer 40 and the secondary resin layer 50 is preferably 0.15 or less. More preferably, a value obtained by subtracting the refractive index of the primary resin layer 40 from the refractive index of the secondary resin layer 50 at a wavelength of 546 nm is 0 or more and 0.10 or less.

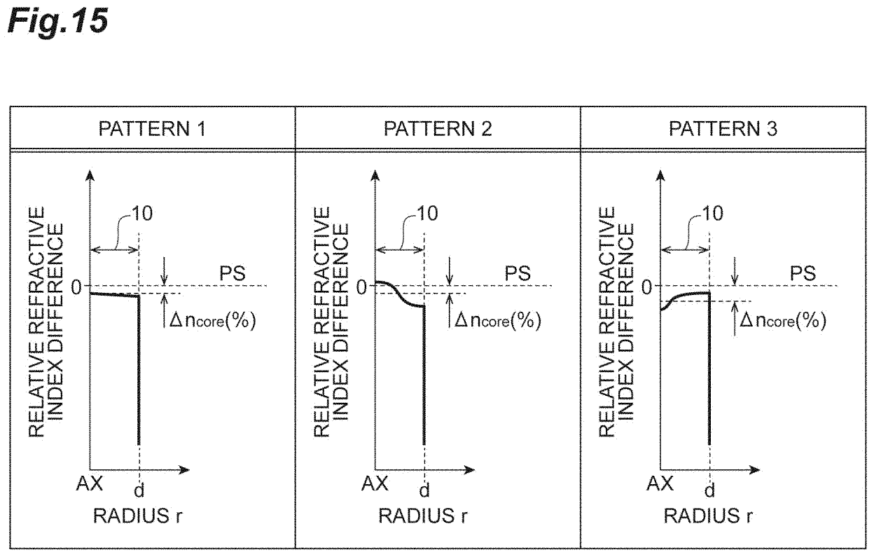

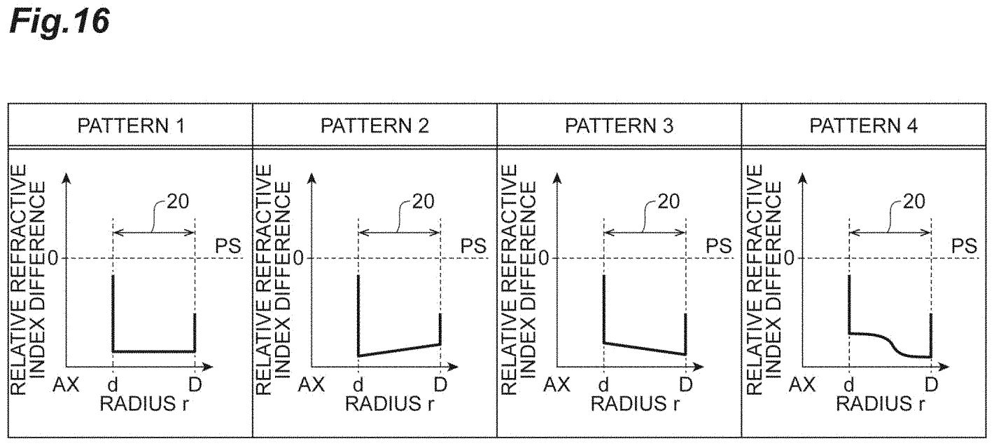

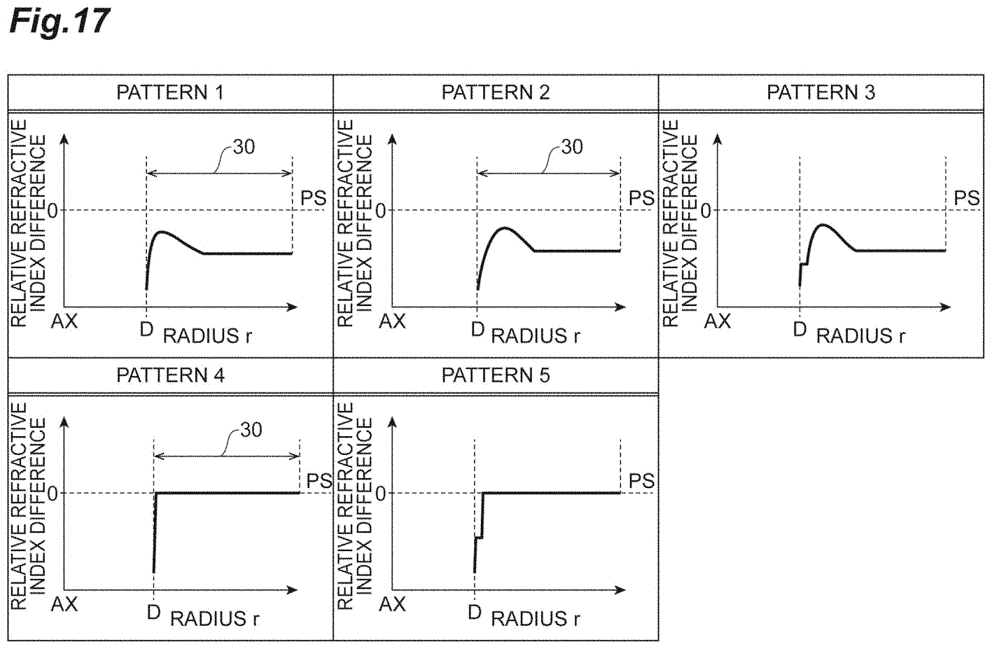

Next, the refractive index profile of the region including the core 10 and the cladding portions having a depressed cladding structure surrounding the core 10 is not limited to the stepped form as illustrated in FIGS. 2A and 2B. For example, it is possible to use a combination of various shapes as illustrated in FIGS. 15 to 17. FIG. 15 is a diagram illustrating examples of various refractive index profiles applicable to the core 10. FIG. 16 is a diagram illustrating examples of various refractive index profiles applicable to the first cladding 20. FIG. 17 is a diagram illustrating examples of various refractive index profiles applicable to the second cladding 30.

As illustrated in FIG. 15, the core 10 may have any profile shape out of Patterns 1 to 3. The Pattern 1 has a profile shape in which the refractive index of the core 10 decreases linearly from the optical axis AX in the radial direction r. The pattern 2 has a profile shape including a portion in which the core 10 has a refractive index higher than PS (it is sufficient to have an average refractive index that is PS or less as a whole). The Pattern 3 has a profile shape in which the refractive index of the core 10 increases from the optical axis AX in the radial direction r.

As illustrated in FIG. 16, the first cladding 20 may have any profile shape out of Patterns 1 to 4. The Pattern 1 has a profile shape in which the first cladding 20 has a uniform refractive index (variation in the relative refractive index difference from the optical axis AX in the radial direction r is ±0.01% or less). The Pattern 2 has a profile shape in which the refractive index of the first cladding 20 increases linearly in the radial direction r. The Pattern 3 has a profile shape in which the refractive index of the first cladding 20 decreases linearly in the radial direction r. The Pattern 4 has a profile shape having the refractive index different between the inner region and the outer region of the first cladding 20.

Furthermore, as illustrated in FIG. 17, the second cladding 30 may have any profile shape of Patterns 1 to 5. Note that the Patterns 1 to 3 have profile shapes in a case where the second cladding 30 is comprised of silica glass doped with F. The Patterns 4 and 5 have profile shapes in a case where the second cladding 30 is comprised of pure silica glass. Specifically, the Pattern 1 has a profile shape in which the refractive index peak in the inner region 30A of the second cladding 30 is shifted toward the core 10 and the outer region 30B has a uniform refractive index. The Pattern 2 has a profile shape in which the profile shape of the inner region 30A in the second cladding 30 is adjusted to be symmetric in the radial direction r, and the outer region 30B has a uniform refractive index. The Pattern 3, similarly to Pattern 2, has a profile shape in which the inner region 30A of the second cladding 30 includes a region where the refractive index is uniform in the radial direction r in the vicinity of the interface between the first cladding 20 and the second cladding 30. The Pattern 4 has a profile shape in which the refractive index is adjusted to a stepped form in the vicinity of the interface between the first cladding 20 and the second cladding 30. The Pattern 5 illustrates a profile shape in which a region having a uniform refractive index is provided in the vicinity of the interface between the first cladding 20 and the second cladding 30.

What is claimed is:

1. An optical fiber comprising:
a core including at least a region which contains chlorine and having an average refractive index lower than a refractive index of pure silica glass;
a first cladding surrounding the core, the first cladding containing at least fluorine and having a refractive index lower than an average refractive index of the core;
a second cladding surrounding the first cladding, the second cladding having a refractive index higher than that of the first cladding; and
a resin coating surrounding the second cladding,
wherein an effective area A_{eff} at a wavelength of 1550 nm is 130 μm² or more and 170 μm² or less,
a ratio (A_{eff}/λ_{C}) of the effective area A_{eff} to a cutoff wavelength λ_{C} is 85.0 μm or more,
a bending loss of an LP01 mode at a wavelength of 1550 nm and at a bending radius of 15 mm is less than 4.9 dB per 10 turns, and
the resin coating includes at least a primary resin layer having a Young's modulus of 0.3 MPa or less.

2. The optical fiber according to claim 1,
wherein the second cladding is comprised of pure silica glass or silica glass containing at least fluorine.

3. The optical fiber according to claim 1,
wherein the effective area A_{eff} is 135 μm² or more and 165 μm² or less.

4. The optical fiber according to claim 1,
wherein the cutoff wavelength is 1630 nm or less.

5. The optical fiber according to claim 1,
wherein the ratio (A_{eff}/λ_{C}) is 95 μm or more.

6. The optical fiber according to claim 1,
wherein the ratio (A_{eff}/λ_{C}) is 130 μm or less.

7. The optical fiber according to claim 1,
wherein a mode field diameter of the LP01 mode at a wavelength of 1550 nm is 12.5 μm or more and 14.0 μm or less.

8. The optical fiber according to claim 7,
wherein a bending loss of an LP11 mode at a wavelength of 1550 nm and at a bending radius of 40 mm is 0.10 dB per 2 turns, or more.

9. The optical fiber according to claim 1,
wherein a difference between a first caustic radius and a second caustic radius is 0.90 μm or more, the first caustic radius being defined as a caustic radius R_{C} of the LP01 mode at a wavelength of 1550 nm and at a bending radius of 25 mm, the second caustic radius being defined as a caustic radius R_{C} of the LP01 mode at a wavelength of 1550 nm and at a bending radius of 15 mm.

10. The optical fiber according to claim 1,
wherein R_{C,eff} and ΔD (%) satisfy the following relationship:
R_{C,eff}>1.46+ΔD(%)×1.93(1/%),
where the R_{C,eff} is a ratio of a caustic radius R_{C} of the LP01 mode at a wavelength of 1550 nm and at a bending radius of 15 mm to a mode field diameter of the LP01 mode at the wavelength of 1550 nm, and the ΔD (%) is a relative refractive index difference between an average refractive index of the first cladding and a maximum refractive index of an inner region in the second cladding.

11. The optical fiber according to claim 1,
wherein the optical fiber has a refractive index profile satisfying the following relationship:
0.15≤Δn≤0.29;
0.02≤ΔD≤Δn+0.05;
2.0≤D/d≤3.7;
2.55≤T≤3.05; and
−0.22≤ΔJ−0.056 (μm⁻¹)×Δn×(D (μm)−d (μm)),
where the Δn is a relative refractive index difference between the average refractive index of the core and the refractive index of the first cladding, the ΔD a relative refractive index difference between the refractive index of the first cladding and a maximum refractive index in an inner region of the second cladding, the d is a radius of the core, the D is an outer diameter of the first cladding, the T is a ratio of an outer diameter of the second cladding to the outer diameter of the first cladding, and the ΔJ is a relative refractive index difference between the refractive index of the first cladding and a minimum refractive index of an outer region of the second cladding.

12. The optical fiber according to claim 1,
wherein the resin coating further includes a secondary resin layer surrounding the primary resin layer.

13. The optical fiber according to claim 12,
wherein the secondary resin layer has a Young's modulus of 800 MPa or more.

14. The optical fiber according to claim 12,
wherein an absolute value of a refractive index difference at a wavelength of 546 nm between the primary resin layer and the secondary resin layer is 0.15 or less.

15. The optical fiber according to claim 1,
wherein an absolute value of a refractive index difference at a wavelength of 546 nm between an outer region of the second cladding and the primary resin layer is 0.08 or less.
